(19) United States
(12) Patent Application Publication
(10) Pub. No.: US 2005/0166444 A1
(43) Pub. Date: Aug. 4, 2005

(54) Spinner bait blade

(76) Inventor: Anthony L. Taylor, Medon, TN (US)

Correspondence Address: LITMAN LAW OFFICES, LTD, PO BOX 15035, CRYSTAL CITY STATION, ARLINGTON, VA, 22215, US

(21) Appl. No.: 11/032,009

(22) Filed: Jan. 11, 2005

Related U.S. Application Data
(60) Provisional application No. 60/541,068, filed on Feb. 3, 2004.

(51) Int. Cl. A01K 85/10

(52) U.S. Cl. 43/42.13

(57) ABSTRACT

The spinner bait blade is an elongated, flat strip having a twisted portion and a tail portion. The elongated twisted portion is twisted about its own longitudinal axis from a front to a back of the twisted portion. The tail comprises a continuation of the flat strip of material beyond the back of the twisted portion that extends at an angle away from the longitudinal axis. The spinner bait blade may be attached to a conventional spinner bait frame, or to an L-shaped frame. The speed of rotation when the blade is drawn through the water creates the illusion of solid, moving bait, and enables the lure to be used as a spinner bait, a buzz bait, or a surface popper.

### CROSS-REFERENCE TO RELATED APPLICATION

This application claims the benefit of U.S. Provisional Patent Application Ser. No. 60/541,068, filed Feb. 3, 2004.

### BACKGROUND OF THE INVENTION

1. Field of the Invention

The present invention relates to fishing lures. Specifically, the present invention relates to a spinner bait blade, which may be used in a spinner bait lure, as a buzz bait, or in place of some surface lures, such as surface poppers. The spinner bait blade may also be used as a part of, or in combination with, other lures, such as crankbait and jig lures.

2. Description of the Related Art

The art of fishing lures is crowded with patents describing fishing lures that are purportedly in one way or another better adapted to attract fish and/or trigger a strike than other similar lures. One family of lures, known as “spinner bait” lures, are designed to work beneath the water surface and include some rotating element that shimmers or flashes reflected light, as would a natural fish, to attract predators. Another family of lures, sometimes referred to as “buzzers”, is designed to work at the water surface and generally also include a rotating element intended to splash and make noise to attract predators. Buzzers can be shiny, dark or transparent. There is also a family of lures known as “spoons,” which have a spoon shape. Spoons wobble and can spin, and are usually shiny. “Spinners” are blades that rotate around a shaft, having one end of the blade attached to the shaft by a clevis to rotate transversely around the axis of the shaft.

Many patented lures include some unique feature to enhance one or another aspect of lure movement or appearance. U.S. Pat. No. 1,993,868, issued Mar. 12, 1935 to Thornberg, describes a fishing lure in the form of a casting plug with a number of faceted beads to act as a bearing on which the lure rotates, and to enhance light reflecting properties of the lure.

U.S. Pat. No. 2,598,965, issued Jun. 3, 1952 to Bain, describes a trolling or casting lure having a spinning lure body mounted in-line ahead of a hook. The blade produces a plurality of light reflections at each revolution for attracting game fish.

U.S. Pat. No. 2,665,516, issued Jan. 12, 1954 to Race describes a trolling lure having a spiral spinning element connected to an L-shaped wire frame by a swivel joint. The L-shaped frame allows the hooks to remain stationary on one side of the lure as the lure rotates independently thereof.

U.S. Pat. No. 4,075,778, issued Feb. 28, 1978 to Howard, describes a fishing lure formed from an elongated strip of metal into flat triangular portions to attract fish by both sight and sound. U.S. Pat. No. 4,174,584, issued Nov. 20, 1979 to Howard, discloses a lure similar to Howard's previous lure described in the '778 patent, but with a smoothly twisted portion instead of flat triangular portions.

U.S. Pat. No. 4,201,008, issued May 6, 1980 to Sparkman, shows a fishing lure for surface fishing having a U-shaped carrier bracket, each leg having a spinner and a fishhook mounted thereon. Each spinner has lugs on opposite ends for mounting on the bracket, a hole in the center, oppositely extending conical protrusions on opposite sides of the hole, and a pair of bent or curved blades.

European Patent No. 261,001, published Mar. 23, 1988, discloses a lure described as shaped axially like a propeller blade with an end bent away from the axis to cause axial rotation while also pushing the blade away from the axis of rotation.

U.S. Pat. No. 4,891,901 to Baker, Jr. describes a number of spinner baits that can also be used as buzz baits and/or with crank baits, which are designed to dive and resurface while being reeled in. All of Baker's lures are designed to follow a straight path during slow lure retrieval and not a “dash-about” path.

U.S. Pat. No. 4,936,041, issued Jun. 26, 1990 to Couture, discloses a trolling lure having a first spoon joined to a second spoon, joined together by two rings which are themselves linked and welded together so that the rings lie in orthogonal planes. The first spoon has a single transverse bend and the second spoon has a par of parallel, transverse bends. The lure is described as having a gentle wiggling action at low trolling speeds, and a more vigorous wiggling action akin to a frightened minnow when trolled at high speeds.

U.S. Pat. No. 5,245,781, issued Sep. 21, 1993 to Helmuth, shows a lure having a helically-shaped body disposed around a lanyard attached inline with hook and line. The body is permitted to rotate on the lanyard.

U.S. Pat. No. 5,586,405, issued Dec. 24, 1996 to Fike, describes a buoyant lure for surface or top water fishing which is attached to a leader line or fishing line by a swivel and is designed to rotate in the water as a result of a spiral configuration. The lure is designed to look like an animal.

U.S. Pat. No. 6,108,961, issued Aug. 29, 2000 to Milawsi et al., describes a lure having a helical body that spins around a strand extending longitudinally through the body and a counterweight to reduce line twist.

U.S. Pat. No. 6,018,901, issued, Feb. 1, 2000 to DuBois, describes a fishing lure having a V-shaped wire harness with the body of the lure mounted on one leg and a helically formed, tubular member mounted on the other leg so that the leg of the wire harness extends through the tubular member, permitting the tubular member to rotate on the harness. A spinner is attached to the same leg of the wire harness as the tubular member by a clevis having opposing ends which extend through the tubular member to facilitate rotation of the tubular member.

Known fishing lures, such as those described above, utilize various means for triggering strike behavior in fish, and are to varying degrees successful. However, there is a need for a lure that looks and moves convincingly like prey, but at the same time is versatile, inexpensive and simple in construction.

None of the above inventions and patents, taken either singly or in combination, is seen to describe the instant invention as claimed. Thus, a spinner bait blade solving the aforementioned problems is desired.

### SUMMARY OF THE INVENTION

The spinner bait blade of the present invention is made from a flat strip of material and has an elongated, twisted central body portion and a tail portion. The elongated twisted body portion includes a head with a hole defined therein for attachment to a lure frame and has at least one 180° twist defined therein. The tail portion forms a lip which extends away from the head and twisted body portions at an angle, so that the lip resists flow of the blade through the water. The head may have an eye painted thereon, and at least one surface may be painted to resemble a fish. The blade is attached to a frame by a swivel using a split ring inserted through the hole in the head end of the twisted body portion.

The frame may be a conventional spinner bait frame formed from wire and having a V-shaped frame with a spinner bait head or jig either molded or crimped onto the end of one leg of the frame, the end of the other leg being formed into an eye receiving a swivel and the spinner bait blade of the present invention attached to the swivel by a split ring or the like. Alternatively, an L-shaped frame having one or both legs ending with a safety pin type connector may be used to enable quick changes of either the spinner bait blade, the jig or lure body, or both. A double L-shaped frame may also be used to permit twin spinner bait blades.

A lure incorporating the spinner bait blade may be used as a spinner bait lure at any depth. During retrieval of the spinner bait, the twists in the blade and the resistance of the lip cause instant rotation, create pulsating vibrations, and cause a strobing effect if one side is painted dark and the other side is painted light, or unpainted but polished. The speed of rotation and twists in the blade cause the blade to resemble a solid fish when viewed from any direction, unlike conventional flat spinner bait blades. When an eye and a gill are painted on the side of the blade, the movement and rotation of the blade simulates an injured, fearful fish, thereby attracting the target fish. When drawn in top or surface water, the twists and lip cause the blade to simulate a buzz bait lure, as well as surface popper type lures. In deeper water, the lip acts similarly to a crankbait lip, the angle of the lip adjusting the depth at which the lure travels.

Accordingly, it is a principal object of the invention to provide a spinner bait blade that enables a lure to be used as a spinner bait, buzz bait, or surface popper lure.

It is another object of the invention to eliminate the need to change baits when fishing at different water depths or in different conditions by providing a spinner bait blade with twists and a lip.

It is a further object of the invention to provide spinner bait blade for a lure that can be used as a buzz bait or spinner bait.

It is a further object of the invention to provide a spinner bait blade with twists and a lip so that the rotation and movement of the blade simulates a solid fish when viewed from any direction by a target fish.

Still another object of the invention is to provide a spinner bait blade that forms a lure when mounted on a typical spinner bait frame or a typical L-shaped frame.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 shows an exemplary rig comprising an exemplary pair of spinner bait blades according to the present invention mounted to a pair of L-frames, along with a jig.

FIGS. 2A, 2B, and 2C show front, side, and back views, respectively, of a first exemplary spinner blade according to the present invention having a single twist.

FIGS. 3A, 3B, and 3C show front, side, and back views, respectively, of a second exemplary spinner blade according to the present invention having a double twist.

FIGS. 4A, 4B, and 4C show front, side, and back views, respectively, of a third exemplary spinner blade according to the present invention having a double twist and multiple eyes formed therein.

FIGS. 5A, 5B, and 5C show left side, right side, and back views, respectively, of a fourth exemplary spinner blade according to the present invention having a triple twist.

FIG. 6 is an environmental perspective view of a spinner bait blade according to the present invention mounted on a conventional spinner bait frame to form a spinner bait lure.

FIG. 7 shows an end view of a spinner bait blade according to the present invention as viewed from the head end.

Similar reference characters denote corresponding features consistently throughout the attached drawings.

### DETAILED DESCRIPTION OF THE PREFERRED EMBODIMENTS

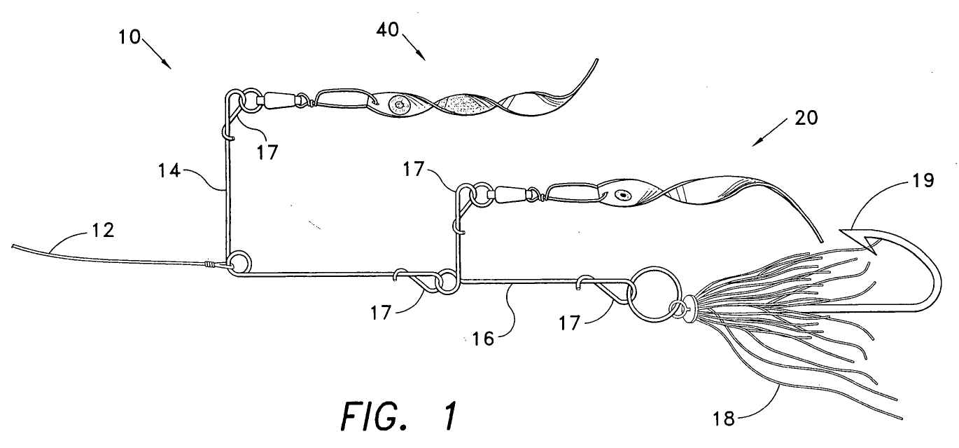

FIG. 1 shows an exemplary configuration of rig 10 for use with the spinner bait blade shown and described herein. Rig 10 includes two L-frames 14, 16 connected in series between leader line 12 and jig 18 and hook 19. The double L-frame configuration provides extra vibration and flash when, for example, fishing in stained or dingy water, and permits the use of twin spinner bait blades 20 and 40. Each L-frame includes a spinner bait blade 20, 40 attached to the extending arm. The second L-frame 14 is optional. It will be noted that both L-frames 14 and 16 have a safety pin type connector 17 formed at both ends of the wire frame to permit a quick substitution of the lure body 18 and/or the spinner bait blades 20 and 40, which may be changed by unhooking the free end of the wire and removing the lure body or spinner bait blade.

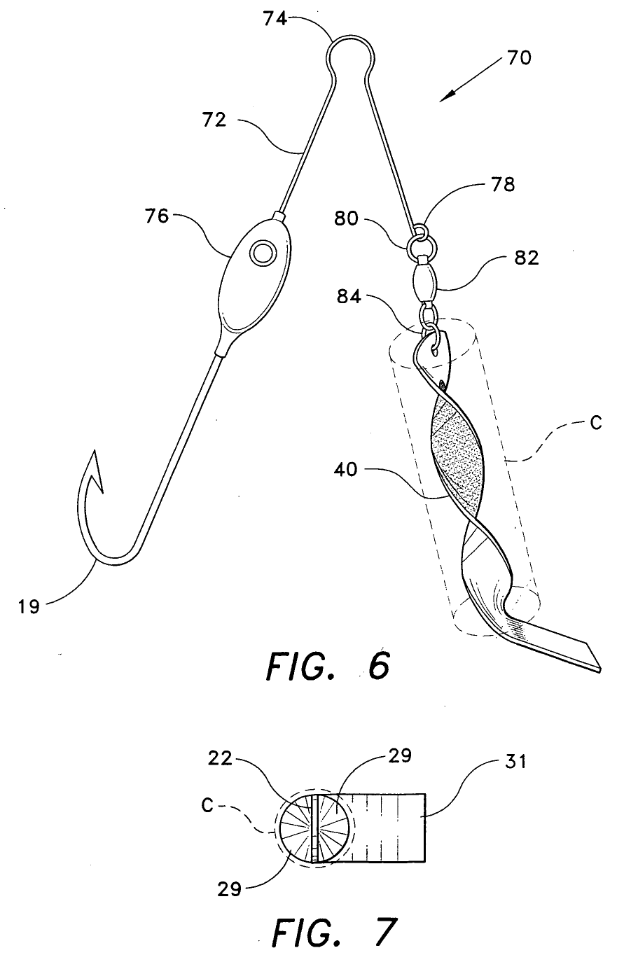

FIG. 6 shows a single spinner bait blade 40 attached to a conventional spinner bait frame 70. The frame 70 is a wire frame shaped like an open safety pin, having two legs 72 with a loop 74 forming the apex of a V-shaped frame. Spinner bait frames can also be formed with an R-shaped loop, or with an eye in place of loop 74. The spinner bait frame 70 may have a spinner bait head 76 molded onto the end of one leg 72, or a jig attached by a crimp sleeve. The head 76 includes a hook 19 attached to the leg 72 with a lead weight molded around the union, usually painted and often equipped with a skirt. The end of the opposite leg 72 is bent into an eye 78 enclosing a ring 80 at the end of a swivel 82, such as a barrel swivel. The spinner bait blade 40 of the present invention is attached to the opposite end of the swivel 82 by a split ring 84 or the like, thereby forming a lure.

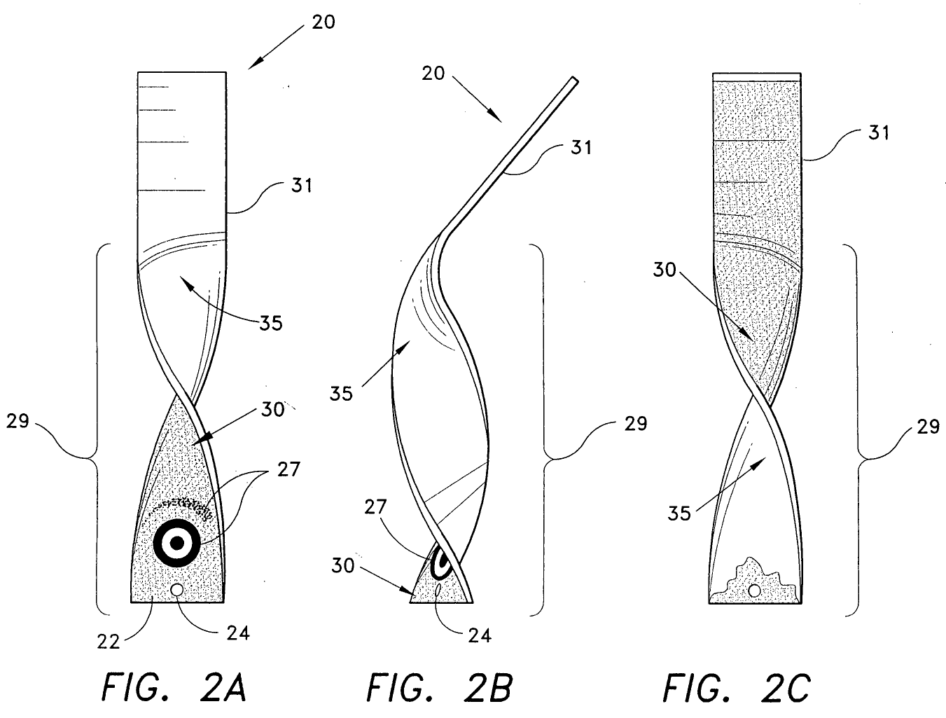

FIGS. 2A, 2B, and 2C show a first embodiment of a spinner bait blade 20 in detail. Blade 20 is formed from a malleable strip of metal or other suitable material, such as plastic, and includes two sections, including a twisted portion 29 and a lip or tail 31. Lure 20 may be made in various lengths and widths to attract different size fish. Lure 20 has a twisted portion 29 having a single 180° twist, although any number of twists may be provided for varying the appearance and movement of lure 20, as will be described in further detail below. The twist is formed gradually, with curvature extending from the head end of the blade 20 to the tail 31.

Tail 31 extends at an angle of at least about 15° to at most 165°, generally more than about 25°and less than about 90° and preferably, about 45° from the axis of twisted portion 29, as shown in FIGS. 2A-2C. The tail 31 is therefore similar to the lip extending from crankbait plugs, except that the tail 31 may be angled both vertically and horizontally, so that the tail 31 is not axially aligned with the twisted portion. Referring to FIGS. 6 and 7, it can be seen that the twisted portion 29 of the blade falls essentially within a cylindrical shell C having a diameter essentially equal to the width of the flat strip of material from which it is formed, while the lip or tail 31 extends outside the cylindrical shell C when viewed from the end of the blade 20. The combination of the relatively narrow twisted portion 29 and the lip or tail 31 extending outward therefrom provides the blade 20 with its unique movement and vibration characteristics. When the blade 20 is made of metal or other malleable material, blade 20 advantageously allows a person to field-adjust the angle of tail 31.

Referring back to FIGS. 2A-2C, hole 24 is provided for attaching a line so that tail 31 trails twisted portion 29 when being pulled through the water by a line (not shown) connected to hole 24. Blade 20 can be provided in different sizes. The following table shows exemplary sizes of the exemplary single-twist lure:

TABLE 1
Exemplary sizes for single twist lure.

| | | | | Length of | |
|---|---|---|---|---|---|
| Size | Overall Length | Width | | twisted portion | |
| small | 1¼″ (3.2 cm) | 5/16″ | (0.8 cm) | 1″ | (2.5 cm) |
| medium | 2¼″ (5.5 cm) | ⅜″ | (1.0 cm) | 1⅝″ | (4.1 cm) |
| large | 3¼″ (8.3 cm) | ½″ | (1.3 cm) | 2⅜″ | (6.0 cm) |

The sizes of the small, medium, and large lures provided above are exemplary. Additional or other size lures may be produced with good result, and the size chosen should depend on the size or appetite of the targeted fish.

Twisted portion 29 causes rotation about the axis of twisted portion 29 incorporated into a lure, as shown in FIGS. 1 and 6, and pulled through the water by a line 12. Tail 31 adds another dimension to the movement of blade 20. Twisted portion 29, in combination with resistance caused by lip or tail 31 causes the blade 20 to have almost instant rotation and pulsating vibration. This combination of rotation and vibration caused by twisted portion 29 and lip or tail 31 unexpectedly generates a very lifelike movement of blade 20. The lip or tail 31 also generates a left-right movement as in crankbait-type lures.

When fished at the top of the water, the lures of FIGS. 1 and 6 perform similarly to a buzz blade, causing splashing disruption of the surface, and can also perform similarly to some surface lures, such as poppers. When below the water surface, these lures perform as a spinner bait, but with the enhanced properties noted above.

Blade 20 includes a number of additional features for purposes of illustration. Lure 20 may be textured with dimples, or other depressions (not shown for purposes of clarity). Dimples, may be provided, e.g., at ⅛″ (3 mm) intervals. Texture adds realism by suggesting scales or other natural surface features of live bait.

Eye 27 is painted on a first side 30 of the strip of material forming blade 20 and may include an arched gill shape adjacent thereto. First side 30 is also painted with color-changing paint that shifts from blue to red depending on the viewing angle. Since the viewing angle varies along the length of the twist, as blade 20 rotates, added realism, depth, and movement is generated. Second side 35 of the strip of material forming blade 20 is painted with silver colored paint. As blade 20 is pulled through the water, the length of blade 20 having 180° twist exposing first side 30 or second side 35 of the strip of material forming lure 20 travels along the twisted portion 29 and appears very lifelike in shape and movement. First and second sides 30, 35 having different colors visually separates the visible lengths of material.

Other colors, such as copper, brass, metallic ice blue, metallic pink, metallic frost green, and yellow, etc., are also contemplated. In addition, combinations of these colors are possible to make blade 20 appear as lifelike as possible.

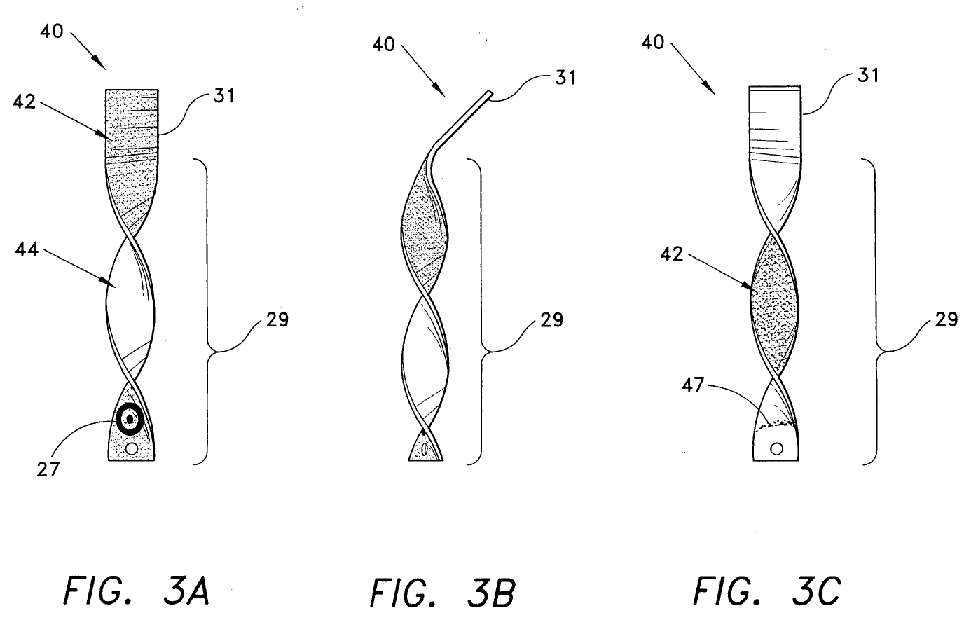

FIGS. 3A, 3B, and 3C show front, side, and back views, respectively, of blade 40. Blade 40 has two complete 180° twists along twisted portion 29 and a tail 31 extending at about a 45° angle from an axis of twisted portion 29. A first side 42 of the material forming lure 40 is, for example, painted a dark metallic paint having flecks of silver and blue. Streaks of metallic pink may be added for increased realism. First side 42 also includes painted eye 27. A second side 44 of the material forming lure 40 is painted metallic brass or yellow and includes a bright pink painted gill 47 to provide yet another visual cue to the target fish that blade 40 is actually a tasty meal.

Double-twist lures may also be made in various sizes. The following table represents various exemplary sizes.

TABLE 2
Exemplary sizes of double-twist lure.

| | | | | Length of |
|---|---|---|---|---|
| Size | Overall Length | | Width | twisted portion |
| small | 1⅞″ | (4.8 cm) | ¼″ (0.6 cm) | 1⅜″ (3.5 cm) |
| medium | 2″ | (5.1 cm) | ¼″ (0.6 cm) | 1½″ (3.8 cm) |
| large | 3¼″ | (8.3 cm) | ½″ (1.3 cm) | 2⅜″ (6.0 cm) |

It should be noted that other sizes are possible and the size chosen will depend on the size and appetite of the targeted fish. Furthermore, the twisted portion length can be extended or shortened to alter the appearance and behavior of the lure. For example, extending the twisted portion length, i.e., making the twists less “tight” will reduce the amount of spin.

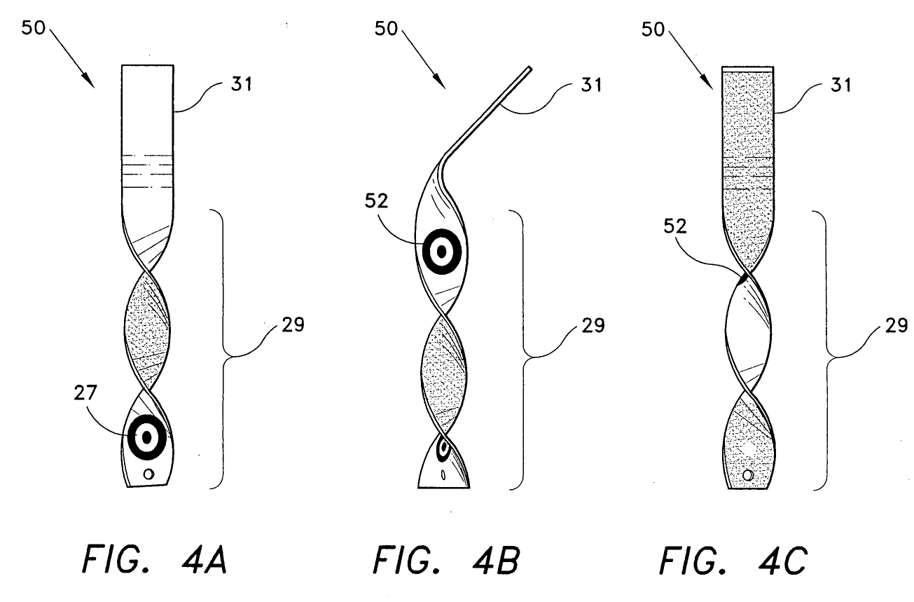

FIGS. 4A, 4B, and 4C show front, side and back views, respectively, of another exemplary embodiment in the form of blade 50. Blade 50 is similar in most respects to blade 40 shown in FIGS. 3A-3C. Specifically, blade 50 includes two full 180° twists along twisted portion 29 and tail 31 angled about 45°. However, blade 50 is provided with an additional painted eye 52. As blade 50 is pulled through the water, additional painted eye 52 is positioned relative to painted eye 27 so that, as blade 50 rotates, the eye appears to jump forward. The number of eyes need not be restricted to two. Depending on the length of the blade and location of the eyes, anywhere from one to four or more eyes can be used, although a single-twist blade having more than two spaced-apart eyes might be excessive. It is also contemplated to provide a pair of eyes side-by-side and even multiple sets of eye pairs along the length of twisted portion 29.

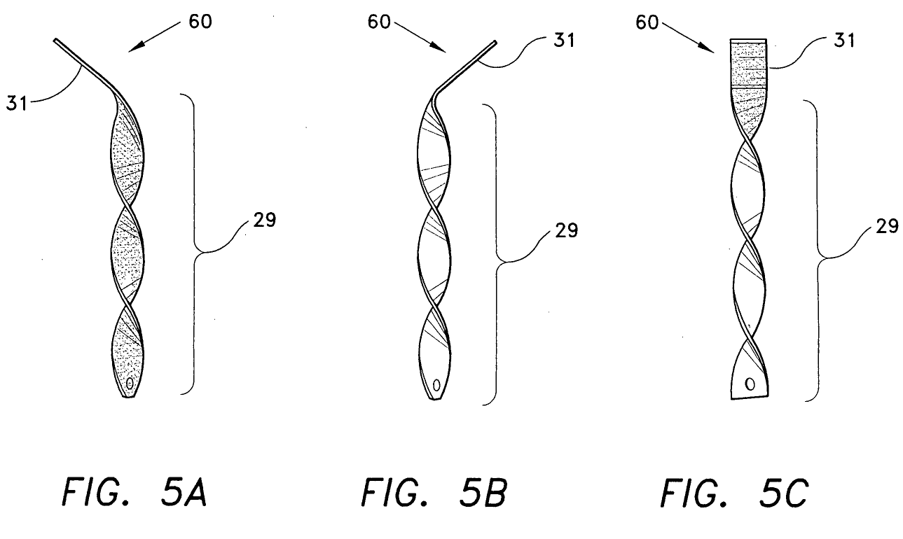

FIGS. 5A, 5B, and 5C show left and right side views, and back views, respectively of blade 60. Blade 60 has three full 180° twists. As mentioned previously, any number of twists or partial twists can be provided. The relative length of twisted portion 29 with respect to tail 31 and the amount of twist in twisted portion 29 will effect the movement of the blade. More tightly twisted blades will rotate faster, and longer twisted portions will result in more stability.

A unique feature of blade 60 is that when viewed from the left, as shown in FIG. 5A, the lure appears dark, as that side is darkly painted with, for example, flat black paint with small portions in metallic pink or gold to add character and realism. However, when viewed from the right as shown in FIG. 5B, the lure appears bright as that side is painted silver or other bright color. When pulled through the water, blade 60 presents a unique strobing effect that is visible from any angle.

Triple-twist blades may also be provided in a variety of sizes. The following table represents exemplary sizes and are not intended to be limiting in any way:

TABLE 3
Exemplary sizes for triple-twist lure.

| | | | | Length of | |
|---|---|---|---|---|---|
| Size | Overall Length | Width | | twisted portion | |
| small | 2¼″ (5.7 cm) | 3/16″ | (0.5 cm) | 1⅞″ | (4.8 cm) |
| medium | 2½″ (6.4 cm) | ¼″ | (0.6 cm) | 2″ | (5.1 cm) |

Note that the “tightness” of the twist in the twisted portion is variable. For instance a single 180° twist can be provided in a medium size lure where the twisted portion alone is over 2 inches long, e.g., 2 ¾ inches. This provides a slower spin when the lure is pulled through the water as well as an elongated fish shape when viewed from the side.

Use of the blade shown and described herein will improve the catch and eliminate the need to change baits when fishing at different water depths or in different conditions. The blade can be used as a buzz bait or spinner bait, in place of some surface lures, or in combination with a jig, crank bait, or plastic worm. The rotation of the blade creates a left-right movement which is similar to the actual movement of bait fish. The blade does not move as a typical spinner bait blade when pulled through the water, but instead it augers itself because of its unique twist. The resistance caused by tail 31 at the back of the lure combined with a minimum amount of twist and the width of the blade forming the lure creates a unique vibration and visual appeal. Furthermore, the unique grab of the front of the blade along with the resistance allows a lure made with this blade to move across the top of the water as a buzz bait. It can be skipped across the top of the water, as may types of known surface lures. It can also be fished at any depth as a regular spinner bait and can be used on a typical spinner bait frame or a typical L-shaped frame.

The blade described herein and lures made with the blade will save the fisherman time and help in locating fish because it does the job of several other lures. The blade in motion appears as a solid image rather than the typical flat image. It appears like a struggling minnow or other small fish. The blade can create a strobing impression when painted as shown in FIGS. 5A-5C and appears amazingly lifelike when moved through the water. The possible ranges of size, width, length, twist, and coloration allow the blade to mimic almost any fish, prey, and escape movement imaginable. By adding extra eyes along the length of the blade, it can imitate a school of bait fish. The sound produced by the blade when worked across the top has a multitude of variations due to length, width, and number of twists.

It is to be understood that the present invention is not limited to the embodiments described above, but encompasses any and all embodiments within the scope of the following claims.

1. A spinner bait blade, comprising:
an elongated, flat, malleable strip of material having a head end, a tail end, and a width, the strip of material being shaped to include:
an elongated twisted body extending from the head end towards the tail end, the body being twisted longitudinally so that the body is substantially encompassed within a cylindrical area having a diameter equal to the width of the strip of material, the head being adapted for attachment to a swivel of a fishing lure; and
a lip formed at the tail end of the strip of material contiguous to the twisted body, the lip extending at an angle away from the twisted body and at least partially extending outside the cylindrical area.

2. The spinner bait blade according to claim 1, wherein said lip extends away from said twisted body at an angle of about 45 degrees.

3. The spinner bait blade of claim 1, wherein said lip extends away from said twisted body at an angle of between about 15° and 165°.

4. The spinner bait blade of claim 1, wherein said lip extends away from said twisted body at an angle of between about 25° and 90°.

5. The spinner bait blade of claim 1, further comprising at least one eye painted on said twisted body.

6. The spinner bait blade of claim 1, wherein said twisted body is twisted one full twist of 180°.

7. The spinner bait blade of claim 1, wherein said twisted body is twisted two full twists of 180° each.

8. The spinner bait blade of claim 1, wherein said twisted body is twisted three full twists of 180° each.

9. The spinner bait blade of claim 1, said twisted body has a hole defined therein at an end opposite said tail.

10. A fishing lure comprising:
a first wire harness having a first leg and a second leg;
a spinner bait blade attached to the first leg of said first wire harness, the spinner bait blade having an elongated twisted body defining a cylindrical shell when rotated, the blade terminating in a lip extending an angle to the twisted body and beyond the cylindrical shell; and
a fishhook and a jig connected to the second leg of said first wire harness.

11. The fishing lure of claim 10, wherein said wire harness is V-shaped.

12. The fishing lure of claim 10, wherein said wire harness is L-shaped.

13. The fishing lure of claim 10, further comprising a second wire harness having a first leg and a second leg, the second wire harness being connected to the second leg of said first wire harness.

14. The fishing lure of claim 13, further comprising:
a second spinner bait blade connected to said first leg of said second wire harness, the second spinner bait blade having an elongated twisted body defining a cylindrical shell when rotated, the blade terminating in a lip extending an angle to the twisted body and beyond the cylindrical shell; and,
a fishhook and a jig connected to said second leg of said second wire harness.

15. The fishing lure of claim 14, wherein said second wire harness is V-shaped.

16. The fishing lure of claim 14, wherein said second wire harness is L-shaped.

17. The fishing lure according to claim 14, further comprising a swivel connecting said second spinner bait blade to the first leg of said second wire harness, whereby said second spinner bait blade rotates axially when the lure is drawn through water.

18. The fishing lure according to claim 10, further comprising a swivel connecting said spinner bait blade to the first leg of said first wire harness, whereby said spinner bait blade rotates axially when the lure is drawn through water.
